(19) United States
(12) Patent Application Publication
(10) Pub. No.: US 2026/0006673 A1
(43) Pub. Date: Jan. 1, 2026

(54) Extended Reality (XR) Peripheral Connection Interval Selection

(71) Applicant: Apple Inc., Cupertino, CA (US)

(72) Inventors: Yann Ly-Gagnon, San Francisco, CA (US); Ravisastry R. Parupudi, San Mateo, CA (US); Matt I. Gillette, San Ramon, CA (US)

(21) Appl. No.: 19/227,204

(22) Filed: Jun. 3, 2025

Related U.S. Application Data
(60) Provisional application No. 63/665,987, filed on Jun. 28, 2024.

(51) Int. Cl. H04W 76/20; G06F 3/038; H04W 4/80; H04W 76/15

(52) U.S. Cl. CPC H04W 76/20; G06F 3/038; H04W 76/15; H04W 4/80

(57) ABSTRACT

A method of selecting a connection interval for wireless communication for peripherals in an extended reality (XR) system comprising connecting, at an XR head mounted display (HMD), with a first peripheral on a first connection interval and a second peripheral on a second connection interval. The method comprises detecting, at the XR HMD, an anticipated change in use from the first peripheral to the second peripheral by a user. The method comprises changing, at the XR HMD, the second connection interval with the second peripheral to a target value prior to an actual change in use by the user.

### PRIORITY CLAIM

Priority is claimed to co-pending U.S. Provisional Patent Application Ser. No. 63/665,987, filed Jun. 28, 2024, which is hereby incorporated herein by reference.

### FIELD

Embodiments of the invention relate to wireless communications, including apparatuses, systems, and methods for selecting connection intervals for peripherals in extended reality (XR).

### DESCRIPTION OF THE RELATED ART

The development of computer systems for augmented reality has increased significantly in recent years. Example augmented reality environments include at least some virtual elements that replace or augment the physical world. Input devices, such as game controllers, touchpads and keyboards for computer systems and other electronic computing devices, are used to interact with virtual/augmented reality environments. Example virtual elements include virtual objects, such as digital images, video, text, icons, and control elements such as buttons and other graphics.

### SUMMARY

Embodiments relate to wireless connection intervals, and more particularly to apparatuses, systems, and methods for selecting a connection interval for wireless communication for peripherals in an extended reality (XR) system. The method can comprise connecting, at an XR head mounted display (HMD), with a first peripheral on a first connection interval and a second peripheral on a second connection interval. In addition, the method can comprise detecting, at the XR HMD, an anticipated change in use from the first peripheral to the second peripheral by a user. Furthermore, the method can comprise changing, at the XR HMD, the second connection interval with the second peripheral to a target value prior to an actual change in use by the user.

Other embodiments relate to an extended reality (XR) head mounted display (HMD) apparatus of an XR system. The system can have a virtual reality game controller (VRGC) and a peripheral. The XR HMD can comprising one or more processors, coupled to a memory, configured to connect, at the XR HMD, with the VRGC on a first connection interval and the peripheral on a second connection interval. In addition, the processors can be configured to detect, at the XR HMD, an anticipated change in use from the VRGC to the peripheral. Furthermore, the processors can be configured to change, at the XR HMD, the second connection interval with the peripheral to a target value prior to an actual change in use by the user.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates a simplified example system environment of an extended reality (XR) system, according to some embodiments.

FIG. 2 illustrates a schematic example of an extended reality (XR) head mounted display (HMD), according to some embodiments.

FIG. 3 illustrates a simplified example wireless topology of the XR system, according to some embodiments.

FIG. 4 illustrates a table of example connection intervals of VR Gaming controllers (VRGCs) of the XR system, according to some embodiments.

FIG. 5 illustrates an example flowchart of the logic for relaxing connection parameters of the XR system, according to some embodiments.

FIG. 6 illustrates a table of example system interactions and example connection intervals between the XR HMD and peripherals for example scenarios, according to some embodiments.

FIG. 7 illustrates a diagram of an example of multi-connection timing, according to some embodiments.

FIG. 8 illustrates a diagram of an example of multi-connection timing, according to some embodiments.

FIG. 9 illustrates a flow chart of an example of a method for selecting a connection interval for wireless communication for peripherals in an extended reality (XR) system, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Extended Reality (XR)—refers to real-and-virtual combined environments and human-machine interactions generated by computer technology and wearables. XR can refer to multiple different types of realities, including: virtual reality (VR), which can give a user the feeling of being physically and spatially in the environment; augmented reality (AR), which can provide a user with additional content overlaid upon their environment; and mixed reality (MR), which can be an advanced form of AR where some virtual elements are inserted and can be interacted with. The XR content can be generated by XR engines, which typically include a rendering engine for graphics, an audio engine for sound, and a physics engine for emulating the laws of physics. When describing an XR experience, various terms are used to differentially refer to several related but distinct environments that the user may sense and/or with which a user may interact (e.g., with inputs detected by a computer system generating the XR experience that cause the computer system generating the XR experience to generate audio, visual, and/or tactile feedback corresponding to various inputs provided to the computer system).

Physical environment—refers to a physical world that a user can sense and/or interact with without the aid of electronic systems. Physical environments include physical articles, such as objects and people. The user can directly sense and/or interact with the physical environment, such as through sight, touch, hearing, taste, and smell.

Extended reality—refers to a wholly or partially simulated environment that the user can sense and/or interact with via an electronic system. In XR, a subset of the user's physical motions, or representations thereof, can be tracked, and, in response, one or more characteristics of one or more virtual objects simulated in the XR environment are adjusted in a manner that comports with at least one law of physics. For example, an XR system may detect a user's head turning and, in response, adjust graphical content and an acoustic field presented to the user in a manner representing how views and sounds would change in a physical environment. The user person may sense and/or interact with an XR object using their senses, such as sight, sound, touch, taste, and smell. Examples of XR include virtual reality, augmented reality and mixed reality.

Virtual reality—refers to a simulated environment that is designed to be based entirely on computer-generated sensory inputs for one or more senses. A VR environment comprises a plurality of virtual objects and/or characters with which a person may sense and/or interact. The user may sense and/or interact with virtual objects in the VR environment through a simulation of the user's presence within the computer-generated environment, and/or through a simulation of a subset of the user's physical movements within the computer-generated environment.

Mixed reality—refers to a simulated environment that is designed to incorporate sensory inputs from the physical environment, or a representation thereof, in addition to including computer-generated sensory inputs such as virtual objects. On a virtual continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). Examples of mixed realities include augmented reality and augmented virtual reality.

Augmented reality—refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. The user indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that the user perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective, such as a viewpoint, different than the perspective captured by the imaging sensors. As another example, a representation of a physical environment may be transformed by graphically modifying, such as enlarging, portions thereof, such that the modified portion may be representative but not photorealistic versions of the originally captured images. As a further example, a representation of a physical environment may be transformed by graphically eliminating or obfuscating portions thereof.

Augmented virtual reality—refers to a simulated environment in which a virtual or computer-generated environment incorporates one or more sensory inputs from the physical environment. The sensory inputs may be representations of one or more characteristics of the physical environment.

In an augmented reality, mixed reality, or virtual reality environment, a view of a three-dimensional environment is visible to the user. The view of the three-dimensional environment is typically visible to the user via one or more display generation components, such as a display or a pair of display modules that provide stereoscopic content to different eyes of the same user, through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions, such as based on the range of vision of the user, size, optical properties or other physical characteristics of the one or more display generation components, and/or the location and/or orientation of the one or more display generation components relative to the eyes of the user. In some embodiments, the region defined by the viewport boundary is larger than a range of vision of the user in one or more dimensions, such as based on the range of vision of the user, size, optical properties or other physical characteristics of the one or more display generation components, and/or the location and/or orientation of the one or more display generation components relative to the eyes of the user. The viewport and viewport boundary typically move as the one or more display generation components move, such as moving with a head of the user for a head mounted device (HMD) or moving with a hand of a user for a handheld device such as a tablet or smartphone. A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location and direction of the head, face, and/or eyes of a user to provide a view of the three-dimensional environment that is perceptually accurate and provides an immersive experience when the user is using the head-mounted device. For devices that include display generation components with virtual passthrough, portions of the physical environment that are visible, such as displayed and/or projected, via the one or more display generation components are based on a field of view of one or more cameras in communication with the display generation components which typically move with the display generation components, such as moving with a head of the user for a head mounted device or moving with a hand of a user for a handheld device, because the viewpoint of the user moves as the field of view of the one or more cameras moves (and the appearance of one or more virtual objects displayed via the one or more display generation components is updated based on the viewpoint of the user). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component, such as moving with a head of the user for a head mounted device or moving with a hand of a user for a handheld device, because the viewpoint of the user moves as the field of view of the user through the partially or fully transparent portions of the display generation components moves (and the appearance of one or more virtual objects is updated based on the viewpoint of the user).

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, WLAN channels may be 22 MHz wide while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

The example embodiments may be further understood with reference to the following description and the related appended drawings, wherein like elements are provided with the same reference numerals. The example embodiments relate to an XR system where a proactive change of a wireless connection interval between an XR head mounted display (HMD) and a peripheral is based on detection (visual or signal based) of an anticipated interaction between a user or a user's hand the peripheral. Such a proactive change of the connection interval can reduce data congestion in a time domain multiplexing communication connection between the HMD and the peripheral(s).

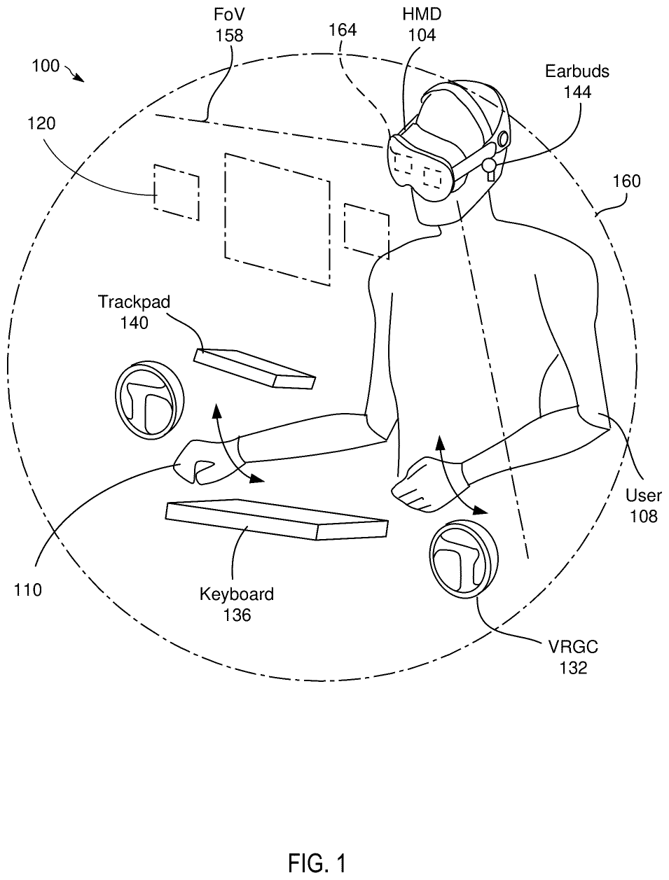

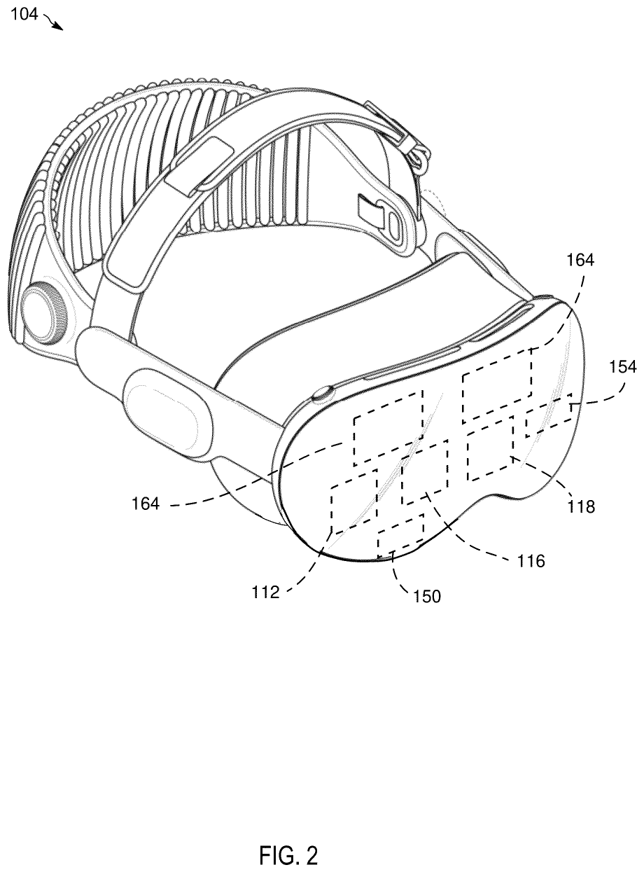

### FIGS. 1 and 2: System Environment and XR HMD

FIG. 1 illustrates a simplified example system environment of an extended reality (XR) system, according to some embodiments. It is noted that the system of FIG. 1 is merely one example of a possible system, and that features of this disclosure may be implemented in any of various systems, as desired. In the depicted embodiment, the system 100 may comprise various components of an XR application. It is noted that although an XR application represents one example of a type of scenario, other XR reality applications may be used.

FIG. 2 illustrates a schematic example of an extended reality (XR) head mounted display (HMD), according to some embodiments. It is noted that the XR HMD of FIG. 2 is merely one example of a possible HMD, and that features of this disclosure may be implemented in any of various HMDs, as desired.

In various embodiments, a mixed reality (MR) system may combine computer generated information (referred to as virtual content) with real world images or a real world view to augment, or add content to, an individual's view of the world, or alternatively may combine representations of real world objects with views of a computer generated three-dimensional (3D) virtual world. Returning to FIG. 1, in some embodiments, components of an MR application or system may, for example, include an XR head mounted display (HMD) 104, such as a headset, helmet, goggles, or glasses, that may be worn by a user 108. In one aspect, the XR HMD 104 can be self-contained. In another aspect, the XR HMD 104 may be connected to an external computer device, such as a PC or a cloud computing system. The XR HMD 104 can comprise one or more processors 112 coupled to a memory 116. The processors 112 can comprise a processing engine configured to render mixed reality frames including virtual content 120 for display by the HMD 104. The HMD 104 can comprise a wireless communication system that allows the HMD 104 to communicate and exchange data via a wireless connection, e.g. 3GPP, Bluetooth or Wi-Fi, with a cloud system and/or the internet. In addition, the HMD 104 can comprise a wireless communication system that allows the HMD 104 to communicate and exchange data via a wireless connection, such as a time domain multiplex signal, e.g. the third-generation partnership project (3GPP), or Bluetooth, with one or more peripherals, such as virtual reality game controllers (VRGCs) 132, a keyboard 136, and/or a trackpad 140.

Furthermore, the HMD 104 can comprise a wireless communication system that allows the HMD 104 to communicate and exchange data via a wireless connection, such as a time domain multiplex signal, e.g. Bluetooth, with an audio device, such as earbuds 144. The XR HMD 104 may communicate with one or more peripherals, such as the VRGC 132, the keyboard 136, the trackpad 140 and the earbuds 144, via one or more wired or wireless communication channels (e.g., 3GPP, BLUETOOTH, IEEE 802.11x, IEEE 802.16x, IEEE 802.3x, etc.). The one or more processors 112 can be coupled to one or more antennas or one or more baseband processors 118 coupled to the one or more antennas.

In one aspect, video data representing at least some portions of an environment (which may comprise both real and virtual objects) of the user 108 may be captured using world or visual sensors 150 (which may include, for example, image sensors, video cameras, and the like). The sensors 150 can include sensors capable of tracking peripherals, such as the VRGCs 132, the keyboard 136, the trackpad 140 or other desired peripherals. In additions, the sensors 150 can include sensors capable of tracking the user 108 or the user's hands 110. Virtual objects of the environment may be generated, for example, by VR (virtual reality), AR (augmented reality) or MR (mixed reality) applications in some embodiments. One or more user sensors 154, such as gaze tracking sensors, may be employed by the HMD 104 to monitor various aspects of the behavior and movement of the user 108; for example, the line-of-sight or gaze of the user 108 and/or a field-of-vision (FoV) 158 of the user 108 or the XR HMD 104 may be tracked using sensors directed at the individual's eyes.

A 3D virtual view 160 may comprise a three-dimensional (3D) space including virtual content 120 at different depths that the user 108 sees when using the XR system 100. In some embodiments, in the 3D virtual view 160, the virtual content 120 may be overlaid on or composited in a view of the user's 108 environment with respect to the user's current line of sight that is provided by the HMD 104. The HMD 104 may implement any of various types of virtual reality projection technologies in different embodiments. For example, the HMD 104 may implement a near-eye VR technique that displays left and right images on displays 164 in front of the user's 108 eyes, such as techniques using DLP (digital light processing), LCD (liquid crystal display) and LCOS (liquid crystal on silicon) technology VR systems. As another example, the HMD 104 may comprise a direct retinal projector system that scans left and right images, pixel by pixel, to the user's 108 eyes. To scan the images, left and right projectors may generate beams that are directed to left and right reflective components (e.g., ellipsoid mirrors) located in front of the user's 108 eyes; the reflective components may reflect the beams to the eyes. To create a three-dimensional (3D) effect, virtual content 120 at different depths or distances in the 3D virtual view 160 may be shifted left or right in the two images as a function of the triangulation of distance, with nearer objects shifted more than more distant objects.

In some embodiments, the XR system 100 may include one or more other components or peripherals. For example, the system 100 may include a cursor control device (e.g. a mouse or a trackpad 140) for moving a virtual cursor in the 3D virtual view 160 to interact with the virtual content 120. As another example, the system 100 may include an input device (e.g. a keyboard 136) for inputting information in the 3D virtual view 160 to interact with the virtual content 120. Other types of virtual devices, such as virtual keyboards, buttons, knobs and the like may be included in the 3D virtual view 160 in some embodiments.

The system 100 can comprise different types of electronic systems that enable a user 108 to sense and/or interact with various XR environments 160. Examples include head-mounted systems 104, projection-based systems, heads-up displays (HUDs), vehicle windshields having integrated display capability, windows having integrated display capability, displays formed as lenses designed to be placed on a person's eyes (e.g., similar to contact lenses), headphones/earphones/earbuds 144, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection by digital micromirror devices (DMDs), organic LEDs (OLEDs), LEDs, micro LEDs (uLEDs), liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

In some embodiments, the processor 112 is configured to manage and coordinate an XR experience for the user. In some embodiments, the processor 112 includes a suitable combination of software, firmware, and/or hardware. In some embodiments, the processor 112 is carried by the XR HMD 104. In some embodiments, the processor 112 can include a computing device that is local or remote relative to the HMD 104. For example, the processor 112 can include a local server located proximate the HMD 104 and the user 108. In another example, the processor 112 can include or can utilize is a remote server located away from the HMD 104 and the user 108 (e.g., a cloud server, central server, etc.).

In some embodiments, the HMD 104 can be worn on a part of the user's body (e.g., on his/her head, on his/her hand, etc.). As such, the HMD 104 can include one or more displays 164 provided to display the XR content. For example, in various embodiments, the HMD 104 can enclose the field-of-view 158 of the user.

While pertinent features of the operating environment are shown in FIG. 1, and pertinent features of the HMD 104 are shown in FIG. 2, it will be appreciated from the present disclosure that various other features have not been illustrated for the sake of brevity and so as not to obscure more pertinent aspects of the example embodiments disclosed herein.

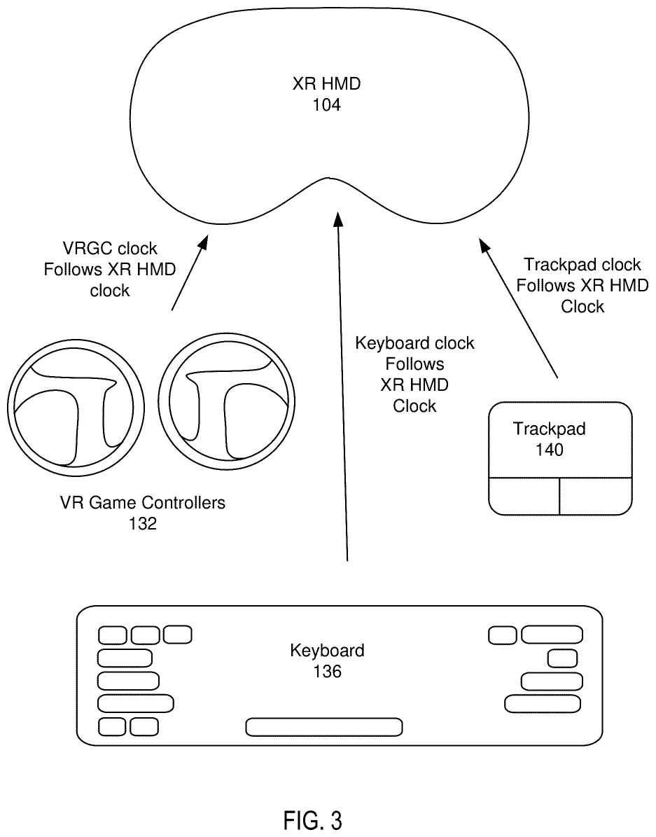

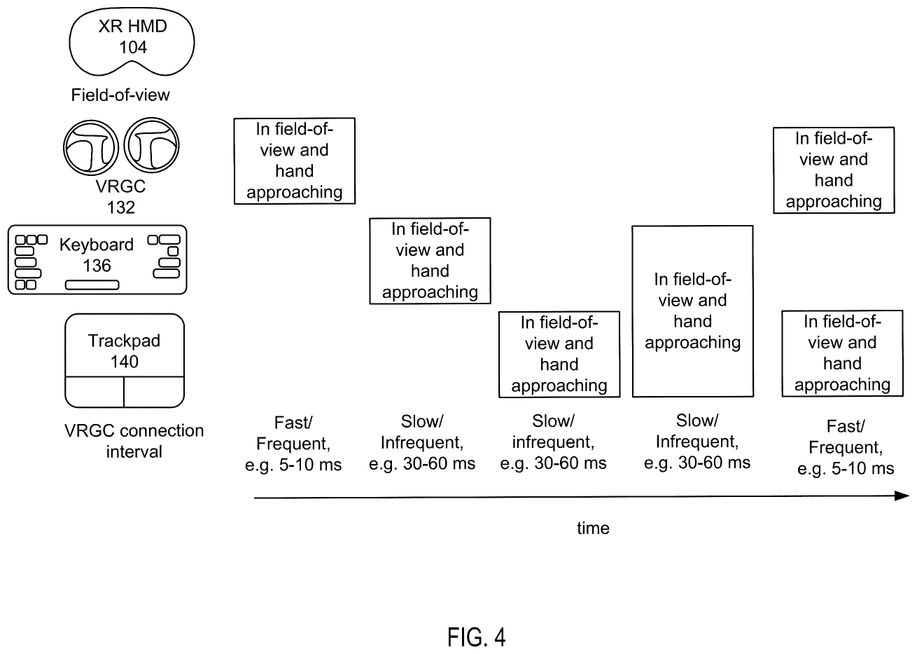

### FIGS. 3 and 4: VRGCs and Low Latency

FIG. 3 illustrates a simplified example wireless topology of the XR system, according to some embodiments. It is noted that the system of FIG. 3 is merely one example of a possible system, and that features of this disclosure may be implemented in any various systems, as desired.

FIG. 4 illustrates a table of example connection intervals of peripherals, such as VR Gaming controllers (VRGCs), keyboards, or trackpads of the XR system, according to some embodiments. It is noted that the system of FIG. 4 is merely one example of a possible system, and that features of this disclosure may be implemented in any various systems, as desired.

The VRGCs 132 may need extremely low latency (e.g. 5-10 milliseconds (ms)) to perform hand-tracking. Latency is a delay between an action and a reaction. Low latency can be desirable when using the HMD 104 in XR. Latency of less than 20 ms can be desirable. In addition, the HMD 104 may support other uses and peripherals, such as audio (e.g. earbuds 144) with Bluetooth Advanced Audio Distribution Profile (A2DP), hearing aids with Bluetooth Low Energy Audio (LEA), wireless fidelity (Wi-Fi or Wi-Fi) with 2.4 GHZ IEEE 802.11, external displays (e.g. Apple® Sidecar®), etc. Other peripherals can include the keyboard 136, the trackpad 140 and/or a mouse. It may be difficult to provide a seamless experience or system interaction with the XR HMD 104 and the keyboard 136, the trackpad 140, the earbuds 144, and/or other peripherals in an airtime provided by a carrier signal with a frequency of 2.4 GHz.

Time division multiplexing (TDM) is a technique that combines multiple low-speed channels into a single high-bandwidth channel by dividing the channel's time into small segments. Each low-speed channel is allowed to transmit its data for a specific period, and the data streams are interleaved in the time domain. In accordance with some embodiments, the HMD 104 can be used to change and control the specific period that each peripheral communicates with the HMD to enable each peripheral to have a relatively low latency with the HMD within the constraints of the radio access technology (RAT) (e.g. 3GPP or Bluetooth) used to connect the HMD with the peripheral.

Airtime is the amount of free time on a channel that devices (i.e. peripherals) have to communicate. Because only one device can use a channel at a time, when communicating using a TDM RAT such as Bluetooth, each channel has only a limited amount of airtime. Peripherals that have a higher connection interval infers that the peripheral will take more airtime since the peripheral will be connecting more frequently with the XR HMD 104. For example, a peripheral with a connection interval of 10 ms will connect with the XR HMD 104 every 10 ms. Devices with longer connection intervals, such as 30 ms, enable a larger gap of time that allows other peripherals time to communicate between the connection interval. Accordingly, peripherals with longer connection intervals put lower stress on the wireless link using the TDM RAT.

The XR HMD 104 can communicate simultaneously with multiple wireless devices, including the VRGCs 132, the keyboard 136, the trackpad 140, the earbuds 144, and/or other peripherals using time domain multiplexing, such as Bluetooth, with connection intervals for each that may be different and that may change. The more peripherals that are connected to the XR HMD 104, the less airtime there is available for each peripheral.

The connection interval is the time period from the start of a connection between the XR HMD 104 and a peripheral to the time of the next connection between the XR HMD 104 and the peripheral. During this time, the HMD can communicate with the peripherals as often as defined by the connection interval. The peripheral must respond to the ping for the HMD 104 to consider the connection to be active. When a peripheral, such as the VRGCs 132 have a very low latency, other use cases, i.e. other peripheral uses in addition to the VRGCs 132, may be compromised when the VRGCs 132 are connected to the HMD 104. Using the VRGCs 132 and other peripherals can be taxing on the airtime. It may not be possible for all of the peripherals to communicate with the HMD 104 with a low latency time.

In accordance with some embodiments, a protocol can be implemented to manage the connection intervals of the peripherals. Namely, instead of a logic that statically decides the peripherals that are connected or used, and changing connection intervals to accommodate such uses, a dynamic run-time logic can be implemented that uses the HMD 104 (e.g. object tracking) to detect a peripheral in the FoV 158 and the user 108 or the user's hand 110 moving towards or away from the peripheral, and proactively changing the connection interval. For example, the HMD 104 (e.g. object tracking) can determine that the user 108 or the user's hand 110 is disengaging or putting down the VRGCs 132 and proactively change the connection interval of the VRGCs 132 and/or another peripheral. The HMD 104 can detect or sense (e.g. with object tracking or peripheral signalling) the user 108 or the user's hand 110 moving away from the VRGCs 132 and towards a different peripheral. The HMD 104 can change the connection interval of the VRGCs 132 with the HMD 104 to a slower or less frequent connection interval. In addition, the HMD 104 104 can detect or sense the user 108 or the user's hand 110 moving towards the different peripheral. The HMD 104 can change the different peripheral to a primary input device and can change the connection interval with the different peripheral to a faster or more frequent connection interval. Proactively changing the connection interval with a peripheral can reduce latency.

According to some embodiments, the XR HMD 104 can detect a change in use of the peripherals and change to a higher (slower or less frequent) connection interval for the VRGCs. The change in use can be based on object tracking, LED pattern detection (in field-of-view (FoV)), and or VRGC key change detection.

With respect to object tracking, when the peripheral (e.g. the keyboard 136 or the trackpad 140) is in the FoV 158 and the user 108 (e.g. the user's hand 110) is visible but not on or engaging the VRGC 132, the HMD 104 can change a connection interval dynamically. Thus, the connection interval may not be statically based on what peripheral is connected, but can be based on runtime logic of what the user 108 is doing with respect to the peripheral. The HMD can pre-emptively detect the user 108 or the user's hand 110 approaching a peripheral, and the connection interval with the peripheral can be proactively changed to a target value, before the user 108 or the user's hand 110 touches the peripheral. For example, if object tracking detects or senses that the user 108 or the user's hand 110 is free from the VRGC 132, the HMD 104 can update the connection interval with the peripheral immediately, and even before the user 108 or the user's hand 110 engages with the peripheral. With object tracking, the peripheral can be detected in the FoV 158 and the user 108 or the user's hand 110 can be detected or sensed moving towards a different peripheral; and the HMD 104 can anticipate the VRGC 132 being disengaged or put down by the user and the user changing use to the different peripheral; and the HMD 104 can change the connection interval with the different peripheral to be a primary input device, with a shorter connection interval.

With respect to LED pattern detection, the HMD 104 can similarly detect or sense an array of LEDs on the VRGC 132, and can determine the orientation of the VRGC 132 based on the LEDs on the VRGC, and that the VRGC 132 is engaged or being held by the user and is within the FoV 158; or that the VRGC 132 is being disengaged or put down.

Some types of peripherals reduce the amount of data transmitted by only sending the change (differential state) during each connection interval. Other, more complex peripherals, such as a VRGC, can send an entire state of the peripheral at every connection interval. In some embodiments, the peripherals can send a Human Interface Device (HID) packet; and a wireless configuration can be changed based on the content of the HID packet.

A change to a higher (slower or less frequent) connection interval can be applied to the peripheral (e.g. the VRGC 132) by sending an over-the-air connection interval updates, connection subrating (Bluetooth Low Energy (LE) specification 5.3 “Connection Enhanced update”) for the keyboard 136 and/or the trackpad 140, or Bluetooth central skip sniff for the keyboard 136 and/or the trackpad 140.

Referring to FIG. 3, the peripherals (e.g. the VRGCs 132, the keyboard 136, and the trackpad 140) can have clocks that follow the clock of the XR HMD 104. This enables each peripheral to use the peripheral's assigned channel time at the appropriate time relative to the other peripherals.

Referring to FIG. 4, when the XR HMD 104 detects a peripheral in the FoV 158 and detects the user 108 or the user's hand 110 approaching a peripheral (e.g. the VRGCs 132, the keyboard 136, and the trackpad 140), the connection interval for the peripheral can be pro-actively changed to a target value for the connection interval. In one example, the target values for the connection interval can be fast, medium and slow with respect to a peripheral. The connection interval selected can depend on the type of peripheral, and the communication needs for the peripheral. Some types of peripherals, such as a VRGC, are configured for a shorter connection interval to provide a desired level of service to the user. Other peripherals, such as a keyboard or trackpad, can operate with a longer connection interval than the VRGC, and still provide a desired level of service to the user.

For example, if the VRGC 132 is in the FoV 158 and the HMD 104 detects the user 108 or the user's hand 110 approaching the VRGC 132, the connection interval can be pro-actively changed to a faster target value (e.g. 5 to 10 ms) with respect to the VRGC 132. As another example, if the keyboard 136 is in the FoV 158 and the HMD 104 detects the user 108 or the user's hand 110 approaching the keyboard 136, the connection interval with the VRGC 132 can be pro-actively changed to a slower target value (e.g. 30 to 60 ms) with respect to the VRGC 132. In addition, the connection interval with the keyboard 136 can be increased from a slower connection interval to a faster connection interval. As another example, if the trackpad 140 is the FoV 158 and the HMD 104 detects the user 108 or the user's hand 110 approaching the trackpad 140, the connection interval with the VRGC 132 can be pro-actively changed to a slower target value (e.g. 30 to 60 ms) with respect to the VRGC 132.

The connection interval of the VRGC 132 can be set to a relatively fast time when in use or when the user's hand 110 is approaching; and can be set to a slower time when the user 108 is using another peripheral or moving away from the VRGC 132.

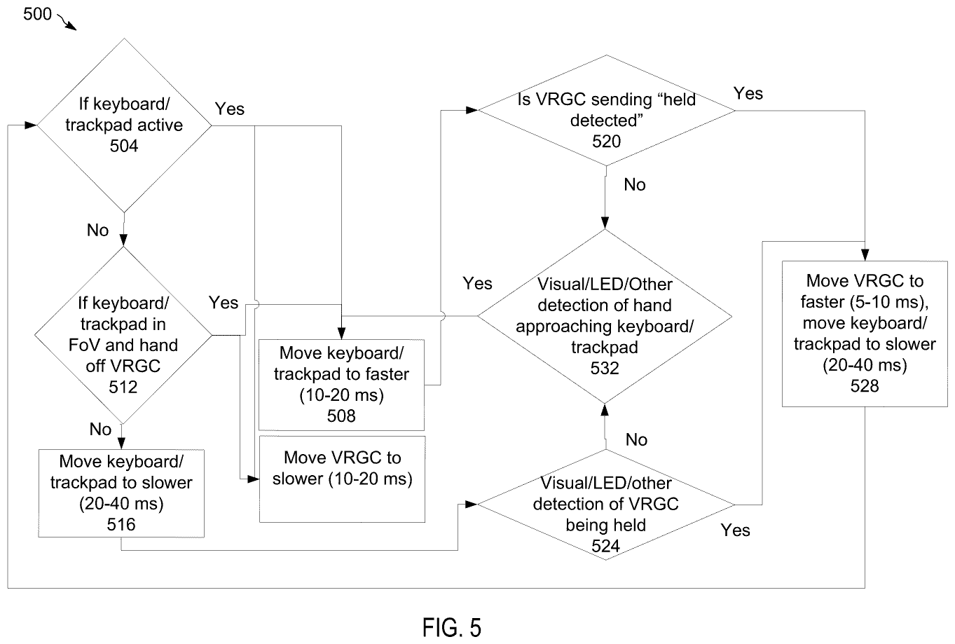

### FIG. 5: Logic for Relaxing Connection Parameters

FIG. 5 illustrates an example flowchart of the logic 500 for relaxing connection interval parameters of the XR system 100, according to some embodiments. It is noted that the logic of FIG. 5 is merely one example of a possible logic, and that features of this disclosure may be implemented in any of various systems, as desired.

The HMD 104 can continuously evaluate whether the peripherals (e.g. the keyboard 136 and/or the trackpad 140) are active 504 or inactive 512. When active 504, the peripheral's connection interval can be changed 508 to a faster relative target value for the connection interval (e.g. 10 to 20 ms). When inactive 512 (in FoV 158 and user 108 or user's hand 110 on VRGC 132), the peripheral's connection interval can be pre-emptively changed 516 to a slower relative target value for the connection interval (e.g. 20 to 40 ms) because the user's hand 110 in not off the VRGC 132 and the peripheral (e.g. the keyboard 136 and/or the trackpad 140) is not active 504. Thus, the HMD 104 can determine that the user 108 and the user's hand 110 will start interacting with the VRGC 132. If the user's hand 110 is off the VRGC 132, then the peripheral (e.g. the keyboard 136 and/or the trackpad 140) can remain on the standard, faster connection interval (e.g. 10 to 20 ms).

If the user's hand 110 is on the VRGC 132 (e.g. the VRGC 132 sending a “held detected” 520 message or a detection of the VRGC 132 being held by the HMD 104 using object tracking, LED detection, etc., or if user 108 or the user's hand 110 is moving away from the peripheral (e.g. the keyboard 136 and/or the trackpad 140 and towards the VRGC 132) 524), the connection interval of the VRGC 132 can be pro-actively changed 528 to a faster relative target value for the connection interval (e.g. 10 to 20 ms), while the peripheral (e.g. the keyboard 136 and/or the trackpad 140) can be changed to a slower relative target value for the connection interval (e.g. 20-40 ms).

If the user's hand 110 is not on the VRGC 132, and the user 108 or the user's hand 110 is detected moving towards the peripheral (e.g. the keyboard 136 and/or the trackpad 140) 532, the connection interval of the peripheral can be changed 508 to a faster relative target value for the connection interval (e.g. 10 to 20 ms).

The HMD 104 can relax the connection interval by providing a longer connection interval for certain peripherals, such as when inaction is detected or anticipated, and can pre-emptively slow or reduce the frequency of the connection interval when the user 108 or the user's hand 110 is detected moving away from the peripheral, to reduce data congestion in the time domain multiplexing communication connection and save energy. In addition, the HMD 104 can periodically poll a peripheral to see if there is data or a connection is needed.

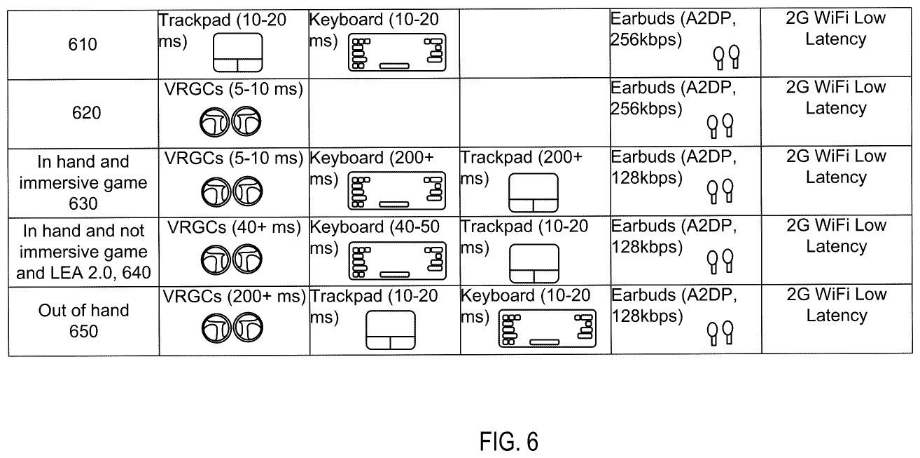

### FIG. 6: Example System Interactions

FIG. 6 illustrates a table of example system interactions and example connection intervals between the XR HMD 104 and peripherals for example scenarios, according to some embodiments. It is noted that the connection intervals and scenarios of FIG. 6 are merely examples, and that features of this disclosure may be implemented in any various systems, as desired. Examples are shown of different scenarios in which peripherals can be utilizing the 2.4 GHz spectrum to communication within the XR HMD system 100.

In a first example 610, a trackpad 140 and a keyboard 136 can have a faster relative connection interval (e.g. 10-20 ms). A wireless audio device, such as the earbuds 144 (indicated by A2DP) can have a slower relative connection interval (e.g. 256 kbps).

In a second example 620, VRGCs 132 can have a faster connection interval (e.g. 5-10 ms) relative to the VRGCs 132. A wireless audio device, such as the earbuds 144 (indicated by A2DP) can have a slower connection interval (e.g. 256 kbps) relative to the wireless audio device.

In a third example 630, with the VRGCs 132 in-hand and with the HMD 104 in an immersive game (e.g. entirely using VRGCs 132, audio playing (A2DP), and a Wi-Fi connection), the VRGCs 132 can take precedence and can have a faster connection interval (e.g. 5-10 ms) relative to the VRGCs 132. A keyboard 136 and/or a trackpad 140 can have a slower connection interval (e.g. 200+ ms) relative to the keyboard 136 and the trackpad 140. A wireless audio device, such as the earbuds 144 (indicated by A2DP) can have a faster connection interval (e.g. 128 kbps) relative to the wireless audio device.

In a fourth example 640, with the VRGCs 132 in-hand and with the HMD 104 not in an immersive game but all peripherals active, the pro-active approach to connection intervals may be useful as the user 108 moves back-and-forth between peripherals. The VRGCs 132 can have a slower connection interval (e.g. 40+ ms) relative to the VRGCs 132. A keyboard 136 and/or a trackpad 140 can have a slower and/or faster connection interval (e.g. 40-50 ms and/or 10-20 ms) relative to the keyboard 136 and the trackpad 140. A wireless audio device, such as the earbuds 144 (indicated by A2DP) can have a faster connection interval (e.g. 128 kbps) relative to the wireless audio device.

In a fifth example 650, with the VRGCs 132 out of hand, the VRGCs 132 can have a slower connection interval (e.g. 200+ ms) relative to the VRGCs 132. A keyboard 136 and/or a trackpad 140 can have a faster connection interval (e.g. 10-20 ms) relative to the keyboard 136 and the trackpad 140. A wireless audio device, such as the earbuds 144 (indicated by A2DP) can have a faster connection interval (e.g. 128 kbps) relative to the wireless audio device.

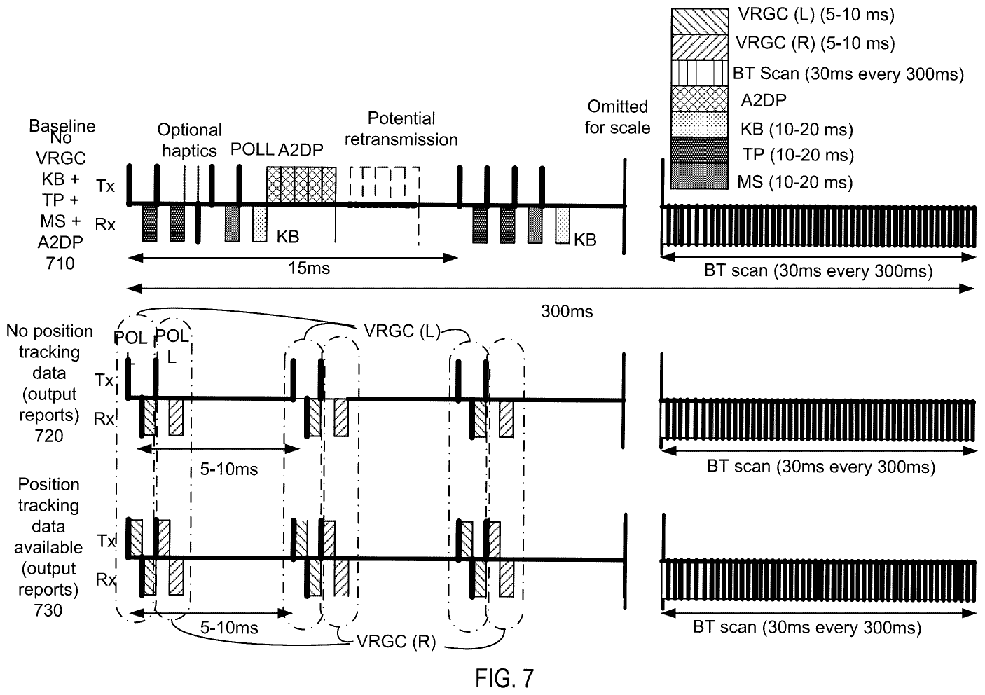

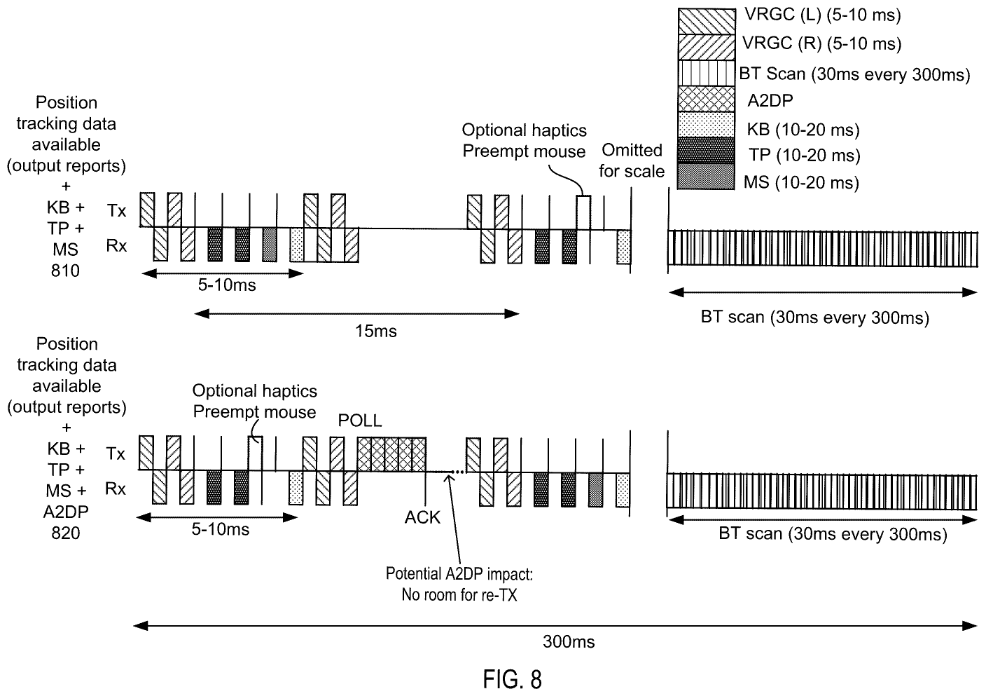

### FIGS. 7 and 8: Multi-Connection Timing Diagrams

FIGS. 7 and 8 illustrate diagrams of example multi-connection timing, according to some embodiments. It is noted that the connection intervals of FIGS. 7 and 8 are merely examples, and that features of this disclosure may be implemented in any various systems, as desired. FIGS. 7 and 8 illustrate a timeline of the sequential behavior of time division multiplexing (TDM) connection, such as Bluetooth. The thin lines in the transmission (TX) show the HMD 104 polling each peripheral. The polling can be a small packet. The thicker lines in the reception (RX) show the data incoming from the peripherals to the HMD 104.

The XR HMD 104 can connect with peripherals at connection intervals with wireless communication comprising a radio access technology (RAT) with time-division multiplexing (TDM), such as Bluetooth or 3GPP. The HMD 104 can connect with multiple peripherals sequentially.

In a first example 710, the connections can comprise a keyboard 136 (indicated at KB), a trackpad 140 (indicated at TP), a mouse (indicated at MS) and a wireless audio device or earbuds 144 (indicated at A2DP), but without VRGCs 132. The connections can involve both transmission (TX) and reception (RX) between the HMD 104 and the peripherals. The HMD 104 may rotate through connections to peripherals in a total interval, such as 300 ms. Thus, the multiple connections with the peripherals can occur at connection intervals within the total interval. In the first example, the connection intervals of the keyboard, trackpad and mouse can be relatively fast, e.g. 10-20 ms. In addition, the connection interval for the earbuds can occur in the available remaining time. It can be seen that without the VRGCs 132 there is relatively more airtime available.

In a second example 720, identified as no position tracking data, the VRGCs can have a relatively fast connection interval, e.g. 5-10 ms. In a third example 730, identified as position tracking data available, the VRGCs can have a relatively fast connection interval, e.g. 5-10 ms. It can be seen that using the VRGCs 132, without the other peripherals, a faster connection interval (e.g. 5-10 ms) is used so that the VRGCs 132 can send data quickly so that the user 108 is able to see the movement.

In a fourth example 810, identified as position tracking data available, has the keyboard, trackpad and mouse connected, as well as the VRGCs. In one aspect, if more than one 15 ms sniff HIDs and 7.5 ms sniff HIDs, then can alternate the 15 ms sniff HIDs. In another aspect, extended sniff can be enabled to allow for haptic feedback.

In a fifth example 820, identified as position tracking data available, has the keyboard, trackpad, mouse and audio connected, as well as the VRGCs. These examples show the limited amount of time available for connection when multiple peripherals are used together. In such a scenario, audio transmission and haptic feedback may suffer. In one aspect, a potential trackpad haptic impact may be an additional slot for haptics may not be available immediately, leading to haptic lags. In another aspect, the host may enable core supplemental specification (CSS) to regain un-used sniff instants for A2DP.

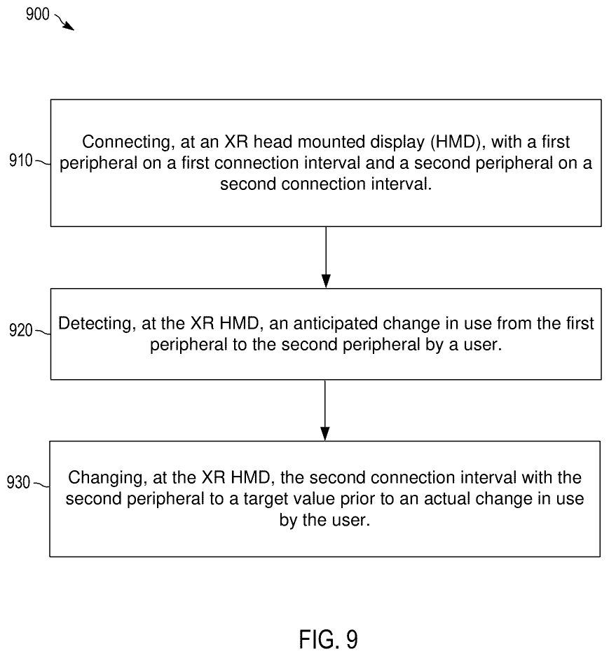

### FIG. 9: Flow Chart for a Method of Selecting a Connection Interval for Wireless Communication for Peripherals in an XR System

FIG. 9 illustrates a flow chart of an example of a method for selecting a connection interval for wireless communication for peripherals in an extended reality (XR) system, according to some embodiments. The method shown in FIG. 9 may be used in conjunction with any of the systems, methods, or devices illustrated in the Figures, among other devices. In various embodiments, some of the method elements shown may be performed concurrently, in a different order than shown, or may be omitted. Additional method elements may also be performed as desired.

In accordance with an embodiment, a method 900 for selecting a connection interval for wireless communication for peripherals in an XR system can comprise connecting 910, at an XR head mounted display (HMD) 104, with a first peripheral on a first connection interval and a second peripheral on a second connection interval. The method 900 can comprise detecting 920, at the XR HMD 104, an anticipated change in use from the first peripheral to the second peripheral by a user 108. The method 900 can comprise changing 930, at the XR HMD 104, the second connection interval with the second peripheral to a target value prior to an actual change in use by the user 108.

In another aspect, the second connection interval can be different than the first connection interval.

In another aspect, the XR HMD 104 can preemptively reduce the second connection interval to increase a frequency of the connection of the second peripheral with the XR HMD prior to the actual change in use by the user 108.

In another aspect, detecting 920 the anticipated change in use can further comprise detecting, at the XR HMD 104, a movement of the user 108 toward the second peripheral. The second peripheral can be previously unengaged by the user 108 and the second peripheral can be in a field-of-view (FoV) 158 of the XR HMD 104.

In another aspect, the target value can be based on the anticipated change in use.

In another aspect, the second connection interval of the second peripheral can have an initial value that is slower; and the target value can be faster than the initial value.

In another aspect, the target value of the second connection interval can enable the XR HMD 104 to communicate with the second peripheral more frequently than a previous value of the second connection interval.

In another aspect, the first and second peripherals can be in a field-of-view (FoV) 158 of the XR HMD 104.

In another aspect, the wireless communication can comprise a radio access technology (RAT) with time-division multiplexing (TDM).

In another aspect, the first peripheral can comprise a virtual reality game controller (VRGC) 132. The second peripheral can comprise a keyboard 136 or a trackpad 140. The first connection interval of the VRGC 132 can have a fast value when in use by the user 108 that is between approximately 3 to 10 milliseconds (ms), and a slow value when not in use by the user 108 that is between approximately 10 to 30 ms. The second connection interval of the keyboard 136 or the trackpad 140 can have a slow value when not in use by the user 108 that is between approximately 20 and 50 ms, and a fast value when in use by the user 108 that is between approximately 10 and 20 ms.

In another aspect, the method 900 can comprise connecting, at the XR HMD 104, with a third peripheral on a third connection interval. The method 900 can comprise detecting, at the XR HMD 104, an anticipated change in use from the first peripheral or the second peripheral to the third peripheral by the user 108. The method 900 can comprise changing, at the XR HMD 104, the third connection interval with the third peripheral to a target value prior to an actual change in use by the user 108. In another aspect, the first peripheral can comprise a virtual reality game controller (VRGC) 132; the second peripheral can comprise a keyboard 136; and the third peripheral can comprise a trackpad 140.

In another aspect, the method 900 can comprise connecting, at the XR HMD 104, with a fourth peripheral on a fourth connection interval; and the fourth peripheral can comprise a wireless audio device 144.

In another aspect, the XR HMD 104 can comprise one or more processors 112 coupled to a memory 116.

In some examples, an extended reality (XR) head mounted display (HMD) 104 apparatus of an XR system with a virtual reality game controller (VRGC) 132 and a peripheral, the XR HMD 104 comprising one or more processors 112, coupled to a memory 116, can be configured to connect, at the XR HMD 104, with the VRGC 132 on a first connection interval and the peripheral on a second connection interval. The processors 112 can be configured to detect, at the XR HMD 104, an anticipated change in use from the VRGC 132 to the peripheral. The one or more processors 112 can be configured to change, at the XR HMD 104, the second connection interval with the peripheral to a target value prior to an actual change in use by the user 108.

In another aspect, the second connection interval can be different than the first connection interval.

In another aspect, the target value of the second connection interval can be based on the anticipated change in use. The target interval of the second connection interval can be implemented prior to an actual change in use.

In another aspect, the processors 112 of the XR HMD 104 can be further configured to preemptively reduce the second connection interval to increase a frequency of the connection of the peripheral with the XR HMD 104 prior to the actual change in use by the user 108.

In another aspect, the processors 112 of the XR HMD 104 can be further configured to detect, at the XR HMD 104, a movement of a user 108 toward the peripheral. The peripheral can be previously unengaged by the user 108 and the peripheral can be in a field-of-view (FoV) 158 of the XR HMD 104.

In another aspect, the target value can be based on the anticipated change in use.

In another aspect, the second connection interval of the peripheral can have an initial value that is slower; and the target value can be faster than the initial value.

In another aspect, the target value of the second connection interval can be more frequent than a previous value of the second connection interval.

Embodiments of the present disclosure may be realized in any of various forms. For example, some embodiments may be realized as a computer-implemented method, a computer readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method of selecting a connection interval for wireless communication for peripherals in an extended reality (XR) system, the method comprising:
connecting, at an XR head mounted display (HMD), with a first peripheral on a first connection interval and a second peripheral on a second connection interval;
detecting, at the XR HMD, an anticipated change in use from the first peripheral to the second peripheral by a user; and
changing, at the XR HMD, the second connection interval with the second peripheral to a target value prior to an actual change in use by the user.

2. The method of claim 1, wherein the XR HMD preemptively reduces the second connection interval to increase a frequency of the connection of the second peripheral with the XR HMD prior to the actual change in use by the user.

3. The method of claim 1, wherein detecting the anticipated change in use further comprises:
detecting, at the XR HMD, a movement of the user toward the second peripheral; and
wherein the second peripheral was previously unengaged by the user;
wherein the second peripheral is in a field-of-view (FoV) of the XR HMD.

4. The method of claim 1, wherein the target value is based on the anticipated change in use.

5. The method of claim 1, wherein the second connection interval of the second peripheral has an initial value that is slower; and wherein the target value is faster than the initial value.

6. The method of claim 1, wherein the target value of the second connection interval enables the XR HMD to communicate with the second peripheral more frequently than a previous value of the second connection interval.

7. The method of claim 1, wherein the first and second peripherals are in a field-of-view (FoV) of the XR HMD.

8. The method of claim 1, wherein the wireless communication further comprises a radio access technology (RAT) with time-division multiplexing (TDM).

9. The method of claim 1, wherein:
the first peripheral comprises a virtual reality game controller (VRGC); and
the second peripheral comprises a keyboard or a trackpad.

10. The method of claim 9, wherein:
the first connection interval of the VRGC has a fast value when in use by the user that is between approximately 3 to 10 milliseconds (ms), and a slow value when not in use by the user that is between approximately 10 to 30 ms; and
the second connection interval of the keyboard or the trackpad has a slow value when not in use by the user that is between approximately 20 and 50 ms, and a fast value when in use by the user that is between approximately 10 and 20 ms.

11. The method of claim 1, further comprising:
connecting, at the XR HMD, with a third peripheral on a third connection interval;
detecting, at the XR HMD, an anticipated change in use from the first peripheral or the second peripheral to the third peripheral by the user; and
changing, at the XR HMD, the third connection interval with the third peripheral to a target value prior to an actual change in use by the user.

12. The method of claim 11, wherein:
the first peripheral comprises a virtual reality game controller (VRGC);
the second peripheral comprises a keyboard; and
the third peripheral comprises a trackpad.

13. The method of claim 11, further comprising:
connecting, at the XR HMD, with a fourth peripheral on a fourth connection interval;
wherein the fourth peripheral comprises a wireless audio device.

14. The method of claim 1, wherein the XR HMD comprises:
one or more processors coupled to a memory.

15. An extended reality (XR) head mounted display (HMD) apparatus of an XR system with a virtual reality game controller (VRGC) and a peripheral, the XR HMD comprising one or more processors, coupled to a memory, configured to:
connect, at the XR HMD, with the VRGC on a first connection interval and the peripheral on a second connection interval;
detect, at the XR HMD, an anticipated change in use from the VRGC to the peripheral; and
change, at the XR HMD, the second connection interval with the peripheral to a target value prior to an actual change in use by a user.

16. The apparatus of claim 15, wherein:
the target value of the second connection interval is based on the anticipated change in use; and
the target interval of the second connection interval is implemented prior to an actual change in use.

17. The apparatus of claim 15, wherein the one or more processors of the XR HMD are further configured to preemptively reduce the second connection interval to increase a frequency of the connection of the peripheral with the XR HMD prior to the actual change in use by the user.

18. The apparatus of claim 15, the one or more processors of the XR HMD are further configured to:
detect, at the XR HMD, a movement of a user toward the peripheral; and
wherein the peripheral was previously unengaged by the user;
wherein the peripheral is in a field-of-view (FoV) of the XR HMD.

19. The apparatus of claim 15, wherein the target value is based on the anticipated change in use.

20. The apparatus of claim 15, wherein the second connection interval of the peripheral has an initial value that is slower; and wherein the target value is faster than the initial value.
